(19) United States
(12) Patent Application Publication
(10) Pub. No.: US 2015/0003037 A1
(43) Pub. Date: Jan. 1, 2015

(54) LUMINOUS STRAW

(71) Applicant: GUAN DAI TECHNOLOGY COMPANY LTD., TAINAN CITY (TW)

(72) Inventor: KE-CHUAN LIU, TAINAN CITY (TW)

(21) Appl. No.: 13/930,574

(22) Filed: Jun. 28, 2013

(51) Int. Cl. F21K 2/06; F21V 33/00

(52) U.S. Cl. CPC F21K 2/06; F21V 33/0004
USPC 362/34

(57) ABSTRACT

This invention relates to a luminous straw in which a hollow straw body is provided. A luminous chamber is segmented in the straw body and an activator is filled into the luminous chamber. An inner tube is further provided in the luminous chamber and a glow chemical is encapsulated in the inner tube. The activator and the glow chemical are mixed together to conduct chemical reaction which results in fluorescent light emitting, and then both ends of the luminous chamber are sealed. The luminous straw body can attract the attention of customers so as to enhance product competitiveness. Therefore, its practical efficacy can be increased in its overall implementation.

### BACKGROUND OF THE INVENTION

1. Field of the Invention

The present invention relates to a luminous straw, more particularly to a luminous straw which can emit fluorescent light in implementation, whereby, the luminous straw can attract the attention of customers so as to enhance its product competitiveness, and then to increase its practical efficacy in its overall implementation.

2. Description of Related Art

Human's body needs regular drinking water so as to supplement water needed by the body. Once the body hasn't supplemented enough water for a long time, dehydration might be occurred in the body and which might further endanger body health or be fatal in severe condition. With the social evolution, living standard of people is improved such that the drinking water is no longer limited to replenish water needed in human's body, but rather is developed into diversified and refined beverages so as to meet people's appetite by a variety of beverages.

Among them, with respect to the straw for drinking beverage, it is generally a hollow tube made by plastic material, which enables people to directly suck up the beverage contained in a beverage container when it is inserted into the inside of the beverage container.

The above straw can achieve expected effect of sucking up beverage contained in a beverage container, however, it is found in practical implementation that straw of this kind is purely a hollow tube made by plastic material, its overall structural design being extremely monotonous such that it is unable to attract people to purchase and is in lack of product competitiveness. There are still rooms for improvement in its overall implementation.

In view of the defect inherent in the conventional straw, the inventor of this invention thus undergoes the research and improvement with respect to the conventional straw with a mind and spirit in pursuit of excellence based on the professional knowledge and experience accumulated in the long term involvement of relevant field, and eventually proposes a novel luminous straw which provides choices of diversified structures with an expectation to achieve the purpose of better implementation value.

### SUMMARY OF THE INVENTION

The main object of the present invention is to provide a luminous straw which can emit fluorescent light in implementation from its luminous chamber of the straw body, whereby, the luminous straw can attract the attention of customers so as to enhance its product competitiveness, and then to increase its practical efficacy in its overall implementation.

The above object and effect of the luminous straw of the present invention can be achieved by the following technique means.

The luminous straw of the present invention has a hollow straw body. A luminous chamber is segmented in the straw body and an activator is filled into the luminous chamber. An inner tube is further provided in the luminous chamber and a glow chemical is encapsulated in the inner tube. The activator and the glow chemical are mixed together to conduct chemical reaction which results in fluorescent light emitting, and then both ends of the luminous chamber are sealed.

### BRIEF DESCRIPTION OF THE DRAWINGS

The present invention will be better understood by the detailed description of the preferred embodiments with reference to the accompanying drawings, in which:

FIG. 1 is a schematic perspective exploded view showing the structure of the present invention.

FIG. 2 is a schematic sectional side view showing the assembly of the present invention.

FIG. 3 is a schematic sectional side view showing the assembly of the present invention.

FIG. 4 is a schematic view showing the using state of the present invention.

### DETAILED DESCRIPTION OF PREFERRED EMBODIMENTS

The technical content, objects and effectiveness of the present invention will become more apparent by the detailed description of the following preferred embodiment of the present invention with reference to the accompanying drawings.

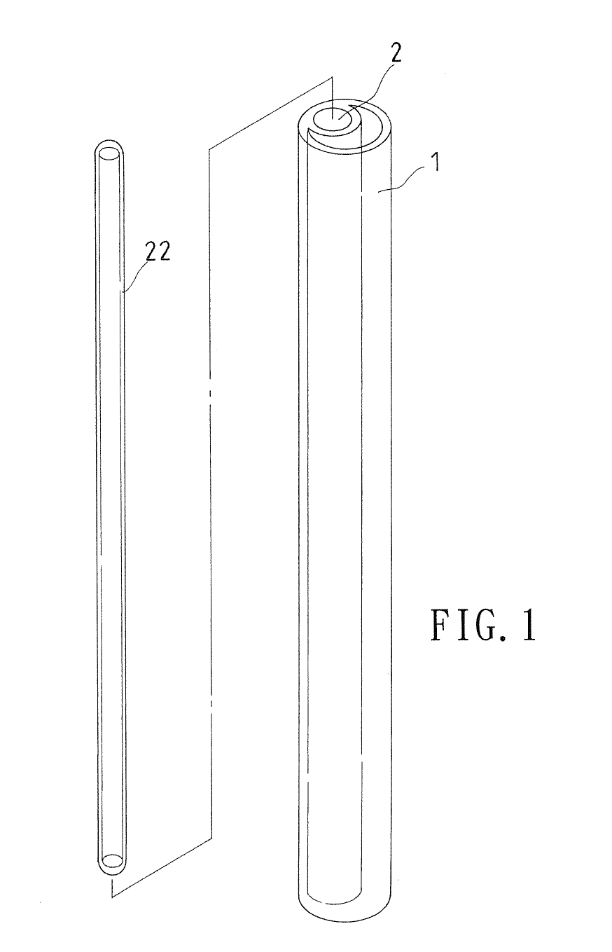

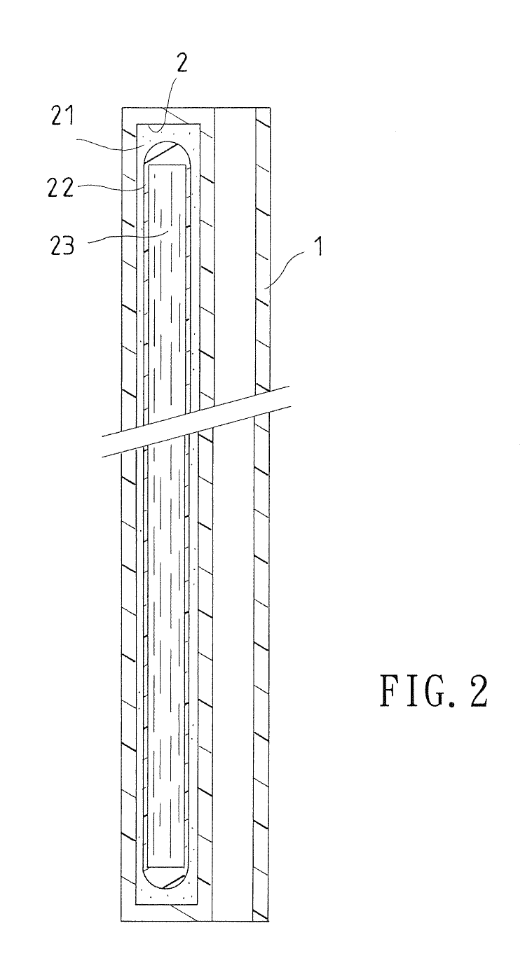

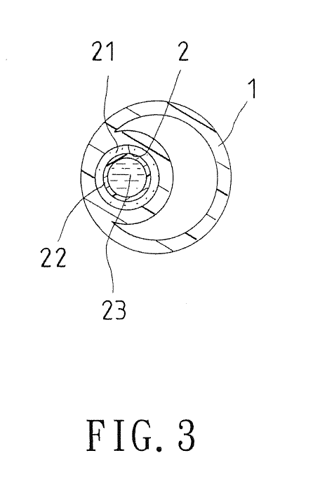

Referring to FIGS. 1 to 3, the luminous straw of the present invention has a hollow straw body (1) in which a luminous chamber (2) is segmented, and an activator (21) is filled into the luminous chamber (2). An inner tube (22) is further provided in the luminous chamber (2) and a glow chemical (23), which can be oxalate compound, is encapsulated in the inner tube (22). The activator (21) and the glow chemical (23) are mixed together to conduct chemical reaction which results in fluorescent light emitting, and then both ends of the luminous chamber (2) are sealed.

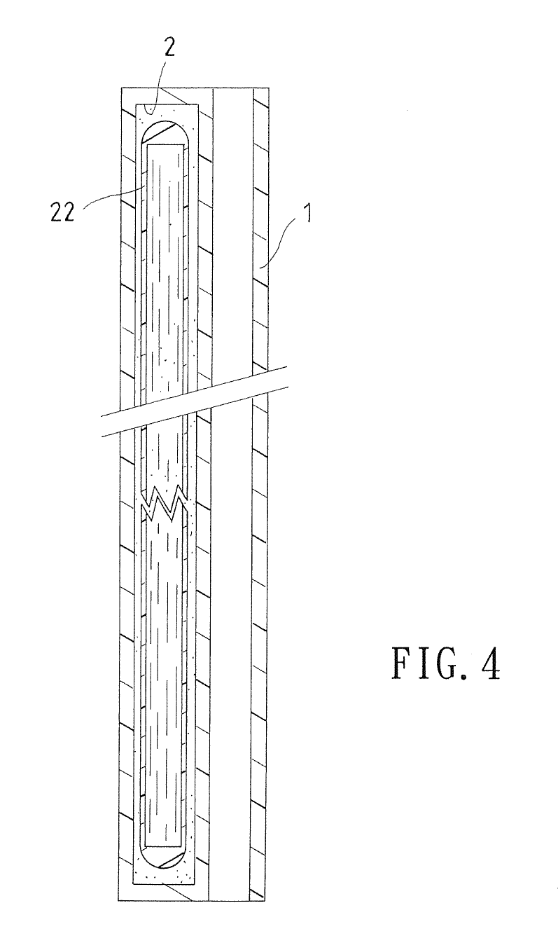

Configuring like this, when in operation as shown in FIG. 4, the straw body (1) is bent at the place corresponding to the inner tube (22) in the luminous chamber (2) so that the inner tube (22) is broken by the bending force applied, and then the glow chemical (23) encapsulated in the inner tube (22) is mixed with the activator (21) in the luminous chamber (2) together to conduct chemical reaction therewith so as to emit fluorescent light corresponding to the color of the glow chemical from the mixture of the activator (21) and the glow chemical (23). Therefore, in the straw body (1) during use, the fluorescent light emitted from the mixture of the activator (21) and the glow chemical (23) can add more aesthetic visual feeling.

Based on the foregoing description of the structural constitution and implementation of the present invention, this invention provides a luminous straw which can emit fluorescent light in implementation from its luminous chamber of the straw body, whereby, the luminous straw can attract the attention of customers so as to enhance its product competitiveness, and then to increase its practical efficacy in its overall implementation, when compared to the conventional structure.

It is noted that persons skilled in the art can ponder out various modifications or variations by referring to the above disclosure. However, any modification or variation conducted without departing from the spirit and scope of this invention are still considered to be within the scope of this invention which is defined by the appended claims.

What is claimed is:

1. A luminous straw, mainly having a hollow straw body and a luminous chamber being segmented therein, an activator being filled into said luminous chamber and an inner tube being further provided in said luminous chamber, a glow chemical being encapsulated in said inner tube, said activator and said glow chemical being allowed to mix together to conduct chemical reaction which results in fluorescent light emitting, and then both ends of said luminous chamber being sealed.
